(19) United States
(12) Patent Application Publication
(10) Pub. No.: US 2024/0005732 A1
(43) Pub. Date: Jan. 4, 2024

(54) AUTOMATIC WAGER SEGMENT GENERATION FROM A RECORDED WAGERED PROGRAM

(71) Applicant: Charter Communications Operating, LLC, St. Louis, MO (US)

(72) Inventors: Michael Lee, Highlands Ranch, CO (US); Glen Hardin, Centennial, CO (US)

(21) Appl. No.: 17/885,162

(22) Filed: Aug. 10, 2022

Related U.S. Application Data
(60) Provisional application No. 63/357,961, filed on Jul. 1, 2022.

(51) Int. Cl. G07F 17/32

(52) U.S. Cl. CPC G07F 17/3244

(57) ABSTRACT

Wager information that identifies a wager is received. A program that corresponds to the wager is determined. A wager segment of the program that is associated with the wager is determined. Presentation of a user-selectable wager image that corresponds to the wager segment is caused on a display device.

### RELATED APPLICATION

This application claims the benefit of U.S. Provisional Patent Application No. 63/357,961, filed on Jul. 1, 2022, entitled “AUTOMATIC WAGER SEGMENT GENERATION FROM A RECORDED WAGERED PROGRAM,” which is hereby incorporated herein by reference in its entirety.

### BACKGROUND

Sports betting has become legal in many states and is growing in popularity.

### SUMMARY

In one embodiment a method is provided. The method includes receiving, by a computing system comprising one or more processor devices, wager information that identifies a wager. The method further includes determining, by the computing system, a program that corresponds to the wager. The method further includes subsequently determining, by the computing system, a wager segment of the program, the wager segment being associated with the wager. The method further includes causing, by the computing system on a display device, presentation of a user-selectable wager image that corresponds to the wager segment.

In another embodiment a computing system is provided. The computing system includes one or more processor devices of one or more computing devices, the one or more processor devices being configured to receive wager information that identifies a wager. The one or more processor devices are further configured to determine a program that corresponds to the wager. The one or more processor devices are further configured to subsequently determine a wager segment of the program, the wager segment being associated with the wager. The one or more processor devices are further configured to cause, on a display device, presentation of a user-selectable wager image that corresponds to the wager segment.

In another embodiment a non-transitory computer-readable storage medium is provided. The non-transitory computer-readable storage medium includes executable instructions configured to cause one or more processor devices to receive wager information that identifies a wager. The instructions are further configured to cause the one or more processor devices to determine a program that corresponds to the wager. The instructions are further configured to cause the one or more processor devices to subsequently determine a wager segment of the program, the wager segment being associated with the wager. The instructions are further configured to cause the one or more processor devices to cause, on a display device, presentation of a user-selectable wager image that corresponds to the wager segment.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1C are block diagrams of an environment suitable for automatic wager segment generation from a recorded wagered program at different points in time according to one embodiment;

FIG. 2 is a flowchart of a method for automatic wager segment generation from a recorded wagered program according to one embodiment;

FIG. 3 is a block diagram of the environment illustrated in FIGS. 1A-1C illustrating automatic wager segment generation for a parlay wager according to one embodiment;

FIG. 4 is block diagram of the environment illustrated in FIGS. 1A-1C illustrating automatic wager segment generation for a wager according to another embodiment;

FIG. 5 is block diagram of the environment illustrated in FIGS. 1A-1C illustrating automatic wager segment generation for a wager according to yet another embodiment;

FIG. 6 is a block diagram of the environment illustrated in FIGS. 1A-1C illustrating automatic wager segment generation for a wager according to yet another embodiment;

FIG. 7 is a block diagram of the environment illustrated in FIGS. 1A-1C illustrating automatic wager segment generation for a wager according to yet another embodiment; and

FIG. 8 is a block diagram of a computing device suitable for implementing examples according to one example.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first message” and “second message,” and does not imply a priority, a type, an importance, or other attribute, unless otherwise stated herein. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Sports betting has become legal in many states and is growing in popularity. Users often use a wager application to identify the particular event that is the subject of the wager, such as a sporting event, and to place a particular wager associated with the event. As an example, a wager application may present an upcoming National Football League (NFL) game between two NFL teams and allow the user to place one or more bets on the game, including, for example, the score at the end of the first quarter, the team who will score first, the player who will first gain 50 yards rushing, or the like.

The user may subscribe to a content streaming service via which the user may subsequently view a recording of the NFL game. If the user is primarily interested in the outcome of their wagers, they may need to utilize the fast forward and/or rewind features of their viewing device to view the content of the NFL game that relates to their wagers, which may take a substantial amount of time. It would be desirable if the content streaming service could present those video segments that are associated with the wager(s) without the need to search through the entire program looking for the relevant video segments relating to the wager(s).

The embodiments disclosed herein implement automatic wager segment generation from a recorded wagered program. Wager information that identifies a wager is received. A program that corresponds to the wager is determined. A wager segment of the program is determined, wherein the wager segment is associated with the wager. A user-selectable wager image is presented on a display device. Upon selection of the user-selectable wager image, the wager segment is presented on the display device. In this manner, a user may quickly view those events in a program that relate to the wager placed by the user.

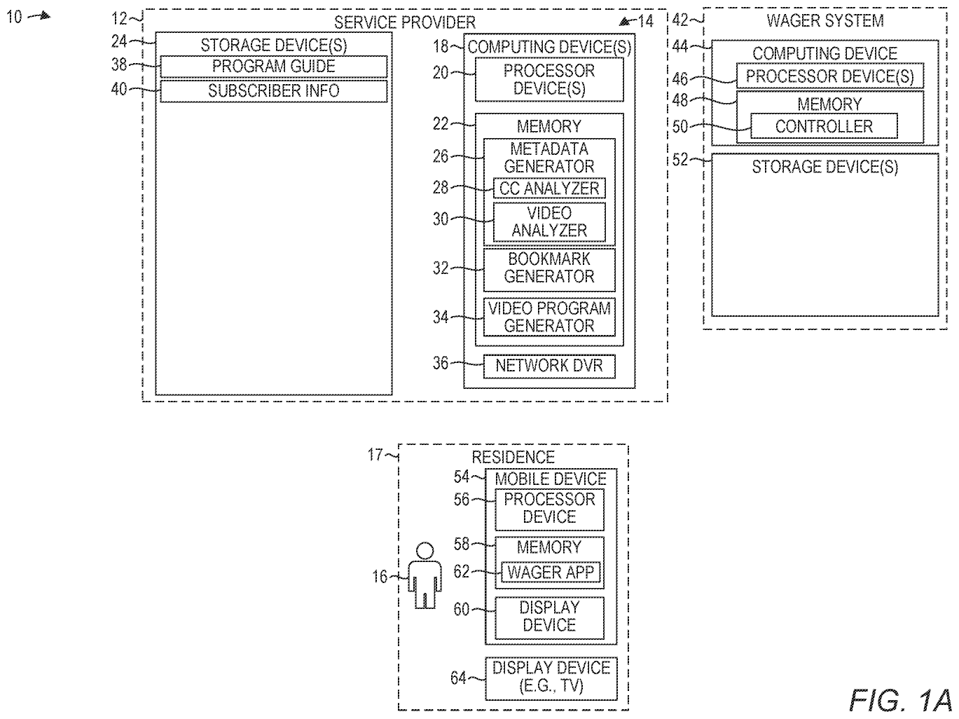

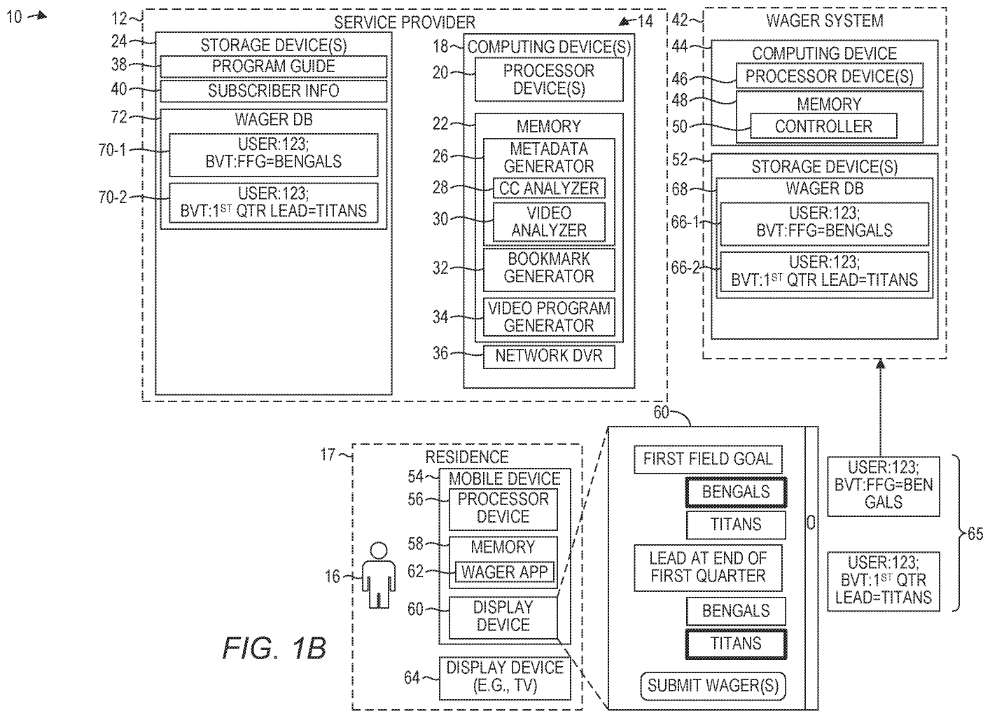

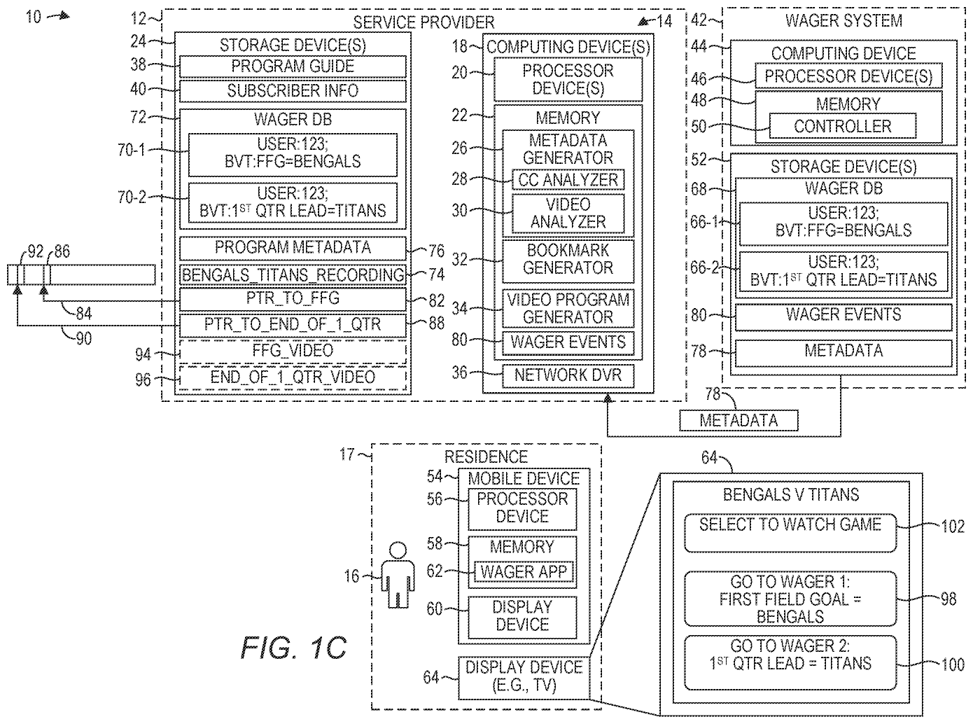

FIG. 1 is a block diagram of an environment 10 suitable for automatic wager segment generation from a recorded wagered program according to one embodiment. The environment 10 includes a service provider 12 that operates a computing system 14 that provides content streaming services to subscribers, such as a subscriber 16 associated with a residence 17. The computing system 14 includes one or more computing devices 18, each of which includes one or more processor devices 20 and a memory 22. The one or more computing devices 18 are communicatively coupled to one or more storage devices 24. While only a single location is illustrated for purposes of simplicity, in some embodiments the service provider 12 may be a national service provider with computing systems 14 distributed geographically across relatively long distances.

As will be discussed in greater detail below, the embodiments utilize metadata that identifies time locations in a recording of a program of events that are associated with wagers. The term wager as used herein relates to the prediction of an outcome of an unpredictable event. The opportunity to place the wager is provided by a wager system that collects such wagers for any of a plurality of different bettors. Typically, a wager involves odds and an associated amount of money that will be paid by the bettor if the prediction is incorrect, or received by the bettor if the prediction is correct. In some embodiments, the computing system 14 may generate the metadata, and in other embodiments, the computing system 14 may be provided the relevant metadata. In embodiments where the computing system 14 generates such metadata, the memory 22 may include a metadata generator 26 that is configured to analyze a recording of a program and generate the metadata. The metadata generator 26 may include, for example, a closed captioning (CC) analyzer 28 that analyzes closed caption information to identify relevant events, and a video analyzer 30 that analyzes the video content of the recorded program to identify relevant events associated with the wagers.

The memory 22 may also include a bookmark generator 32 that is configured to utilize the metadata to generate a bookmark, sometimes referred to as a pointer, to a wager segment location in a recording of the program. The wager segment location is a location of a segment of the program recording that pertains to or is otherwise associated with a wager. The memory 22 may also include a video program generator 34 that uses the metadata to generate new video programs, in some implementations in lieu of bookmarks. The computing device 18 may include or be communicatively coupled to a network digital video recorder 36 that operates to record programs for subscribers.

It is noted that the metadata generator 26, the bookmark generator 32, and the video program generator 34 are illustrated as separate components solely for reasons of explanation, and that in other implementations the functionality described herein to such components could be implemented in a single component or in a greater number of components than three. Moreover, because the metadata generator 26, the bookmark generator 32 and the video program generator 34 are components of the computing device 18, functionality implemented by the metadata generator 26, the bookmark generator 32, and the video program generator 34 may be attributed to the computing device 18 generally. Moreover, in examples where the metadata generator 26, the bookmark generator 32, and the video program generator 34 comprise software instructions that program the processor device 20 to carry out functionality discussed herein, functionality implemented by the metadata generator 26, the bookmark generator 32, and the video program generator 34 may be attributed herein to the processor device 20.

Finally, it is noted that while, for purposes of illustration and simplicity, the computing system 14 is illustrated as including a single computing device 18, in practice, the computing system 14 may comprise a plurality of computing devices 14, each of which may comprise a plurality of processor devices 20. Thus, the functionality described herein with regard to the computing device 18 may in practice be implemented via a plurality of such processor devices 20 implemented via a plurality of computing devices 14.

The storage device 24 includes a program guide 38 that identifies current and future programs that can be streamed to subscribers, and/or recorded by the network DVR 36. The storage device 24 also includes subscriber information 40 that contains information about subscribers of services provided by the service provider 12, configuration options of such subscribers, channels to which the subscribers subscribe, and the like.

The environment 10 includes a wager system 42 that includes a computing device 44, which in turn includes one or more processor devices 46 and a memory 48. The memory 48 may include one or more applications, embodied herein as a controller 50, that causes the processor device 46 to implement the functionality described herein. Because the controller 50 is a component of the computing device 44, functionality implemented by the controller 50 may be attributed to the computing device 44 generally. Moreover, in examples where the controller 50 comprises software instructions that program the processor device 46 to carry out functionality discussed herein, functionality implemented by the controller 50 may be attributed herein to the processor device 46. Moreover, while the wager system 42 is illustrated as being separate from the service provider 12, in some embodiments the wager system 42 may be operated by the service provider 12 and may be part of the computing system 14. The computing device 44 includes or is communicatively coupled to a storage device 52.

The subscriber 16 interacts with a device 54 that includes a processor device 56 and a memory 58. The device 54 includes or is communicatively coupled to a display device 60. The subscriber 16 places wagers via a wager application 62 that executes on the device 54. In this example, the device 54 is a mobile device such as a smartphone, but in other examples, the device 54 may comprise a computing tablet, a desktop or laptop computer, or any other processing device capable of executing the wager application 62 and presenting information on the display device 60. The subscriber 16 may view content provided by the service provider 12 on a display device 64, such as a television.

Referring now to FIG. 1B, the subscriber 16 interacts with the wager application 62 to place two wagers on a future sporting event, in this example, a football game between the Bengals and the Titans. The first wager is a prediction that the Bengals will score the first field goal in the game, and a second wager is a prediction that the Titans will lead the Bengals at the end of the first quarter in the same game. The subscriber 16 submits the wagers, and the wager application 62 sends wager information 65 that identifies the wagers to the computing device 44 of the wager system 42. The wager system 42 may store the wager information 65 in corresponding wager records 66-1 and 66-2 in a wager database 68. The wager system 42 may also send the wager information 65 to the computing system 14 of the service provider 12. The computing system 14 receives the wager information 65 and stores the wager information 65 in corresponding wager records 70-1 and 70-2 in a wager database 72.

The computing device 18 may interact with the network DVR 36 to determine whether the relevant program, in this case an upcoming Bengals and Titans game, has been set to be recorded for the subscriber 16. If not, the computing device 18 may send the network DVR 36 instructions to record the Bengals and Titans game. A recorded program that involves wagers may be referred to herein as a recorded wagered program.

Referring now to FIG. 1C, the Bengals play the Titans, and the network DVR 36 generates a program recording 74 that is accessible to the subscriber 16. In one embodiment, the computing system 14 receives metadata 78 from the computing device 44 of the wager system 42 that contains time locations of events that are associated with the wagers. The wager system 42 may automatically generate hundreds or thousands of metadata 78 that correspond to wagerable events that occurred in the program, and provide such metadata 78 to third parties, such as the computing system 14 of the service provider 12 automatically pursuant to an agreement, or upon request.

The metadata 78 may be in the form of time locations of the events with respect to the program recording 74, or time locations of the events with respect to a game clock of the actual program, in this case an NFL football game. In other words, the time locations may be actual game clock times, such as 10:45 in the first quarter or, alternatively, may refer to that location in the program recording 74 that corresponds to 10:45 in the first quarter of the game. In the case of the former, the computing system 14 may process the metadata 78 to translate the actual game clock times to the corresponding program recording times and store the translated metadata as program metadata 76.

In another embodiment, in lieu of receiving the metadata 78 from the wager system 42, the metadata generator 26 analyzes the program recording 74 to generate the program metadata 76. In particular, the metadata generator 26 utilizes the wager records 70-1 and 70-2 to determine which events in the program recording 74 should be identified, and the CC analyzer 28 and/or the video analyzer 30 processes the program recording 74 to identify the relevant events. The relevant events that are associated with each particular type of wager may be identified in wager event information 80 maintained, for example, by the wager system 42 where the wager system 42 provides the metadata 78, or by the computing device 18 where the computing device 18 processes the program recording 74 to generate the program metadata 76.

The wager event information 80 identifies the event(s) that correspond to each particular type of wager and may differ from implementation to implementation. In some embodiments, the wager event information 80 may be user configurable and thus may differ from subscriber to subscriber. As an example, for a wager as to which team makes the first field goal, as identified in the wager records 66-1 and 70-1, the wager event information 80 may indicate that the event that corresponds to such wager is simply the first field goal of the game. Alternatively, the wager event information 80 may indicate that the events that correspond to such wager is the first field goal as well as each previous unsuccessful attempt at a field goal. As another example, for a wager as to who leads at the end of the first quarter, as identified in the wager records 66-2 and 70-2, the wager event information 80 may indicate that the event that corresponds to such wager is simply the end of the first quarter. Alternatively, the wager event information 80 may indicate that the events that correspond to such wager is the end of the first quarter and each score by either team during the first quarter.

In one embodiment, the computing device 18 accesses the program metadata 76 to generate bookmarks (sometimes referred to herein as pointers) that identify a particular location, or locations, of such events in the program recording 74. The video segments that depict events that correspond to wagers are referred to herein as wager segments, and the pointers identify a beginning of a wager segment and may identify a length of the wager segment.

To identify a location of a wager segment, the bookmark generator 32 may automatically modify a time location of an event identified in the metadata 78 such that the wager segment begins at a point in time prior to the actual event. As an example, if the event is the first field goal, the metadata 78 may include a time location that indicates the first field goal event occurs 12 minutes and 20 seconds into the program recording 74. The bookmark generator 32 may automatically generate a bookmark 82 that, when selected, causes an initiation of playback at a wager segment location 84 prior to the event, such as at 12 minutes and 10 seconds into the program recording 74 to allow the subscriber 16 to view the ten seconds of the game that preceded the first field goal. The period of time prior to the actual event at which the wager segment location 84 should begin may be user configurable and may be maintained, for example, in the subscriber information 40. Thus, for example, the subscriber 16 may identify any desired amount of time, such as 15 seconds, 60 seconds, or the like, prior to the actual event at which the bookmark 82 should be set. The bookmark generator 32 may also automatically define a total length of playback, such as a total amount of time before, during, and after the event, to thereby define a wager segment 86 of the program recording 74 that corresponds to the first field goal. The total length of playback may be stored as metadata of the bookmark 82.

Similarly, based on the metadata 78, the bookmark generator 32 may generate a bookmark 88 that points to a wager segment location 90 of the program recording 74. The wager segment location 90 points to the beginning of a wager segment 92 that, in this example, is an approximately twenty second video segment (10 seconds before and 10 seconds after) depicting the end of the first quarter.

In another embodiment, in lieu of or in addition to generating bookmarks, the computing system 14 may access the program metadata 76 to generate new video programs that include wager segments that depict events that correspond to a wager. For example, for the wager identified in the wager record 70-1, the video program generator 34 may generate a new video program 94 that includes a copy of the wager segment 86 that depicts the first field goal. In an embodiment where the wager event information 80 indicates that the events that correspond to that wager are the first field goal as well as each previous attempt, the new video program 94 may include not only the first field goal but may also include wager segments that depict each unsuccessful field goal attempt prior to the first field goal.

For the wager identified in the wager record 70-2, the video program generator 34 may generate a new video program 96 that includes a copy of the wager segment 92 that depicts the end of the first quarter. In an embodiment where the wager event information 80 indicates that the events that correspond to that wager are the end of the first quarter and each score by either team during the first quarter, the new video program 96 may also include a plurality of wager segments that depict each score in the first quarter. In some embodiments, the computing system 14 may generate the bookmarks 82, 88 and/or the new video programs 94, 96 in real time as the wagered events occur.

In this example, subsequent to the Bengals and Titans game ending, the subscriber 16 accesses streaming services provided by the service provider via the display device 64. The computing system 14 generates user-selectable wager images 98 and 100 and streams the user-selectable wager images 98 and 100 to cause the user-selectable wager images 98 and 100 to be presented on the display device 64. The user-selectable wager image 98 corresponds to the wager regarding who will score the first field goal, and the user-selectable wager image 100 corresponds to the wager regarding who will have the lead at the end of the first quarter.

In embodiments where the computing system 14 generates the bookmarks 82 and 88, the user-selectable wager image 98 is correlated to the bookmark 82 such that selection of the user-selectable wager image 98 by the subscriber 16 causes the computing system 14 to access the bookmark 82 and begin playing the program recording 74 from the wager segment location 84. The bookmark 82 may indicate that the wager segment 86 is twenty seconds long, and the computing system 14 may automatically stop streaming after twenty seconds.

The user-selectable wager image 100 is correlated to the bookmark 88 such that selection of the user-selectable wager image 100 by the subscriber 16 causes the computing system 14 to access the bookmark 88 and begin playing the program recording 74 from the wager segment location 90.

In embodiments where the computing system 14 generates the new video programs 94 and 96, selection of the user-selectable wager image 98 by the subscriber 16 causes the computing system 14 to stream the new video program 94 to the display device 60. Selection of the user-selectable wager image 100 by the subscriber 16 causes the computing system 14 to stream the new video program 96 to the display device 60.

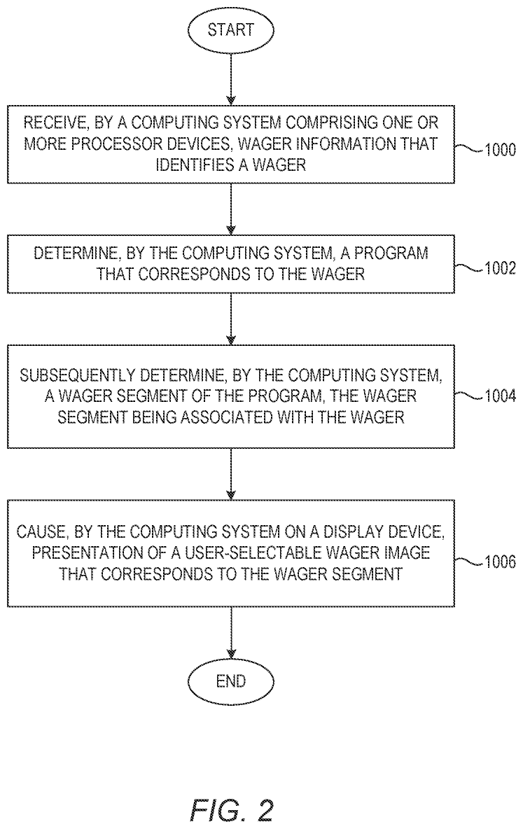

FIG. 2 is a flowchart of a method for automatic wager segment generation from a recorded wagered program according to one embodiment. FIG. 2 will be discussed in conjunction with FIGS. 1A-1C. The computing system 14 receives the wager information 65 that identifies a wager (FIG. 2, block 1000). The computing system 14 determines a program that corresponds to the wager (FIG. 2, block 1002). The computing system 14 may, for example, utilize the program guide 38 to determine the program that corresponds to the wager. The computing system 14 subsequently determines the wager segment 86 of the program, the wager segment 86 being associated with the wager (FIG. 2, block 1004). The computing system 14 causes, on the display device 64, the presentation of the user-selectable wager image 98 that corresponds to the wager segment 86 (FIG. 2, block 1006).

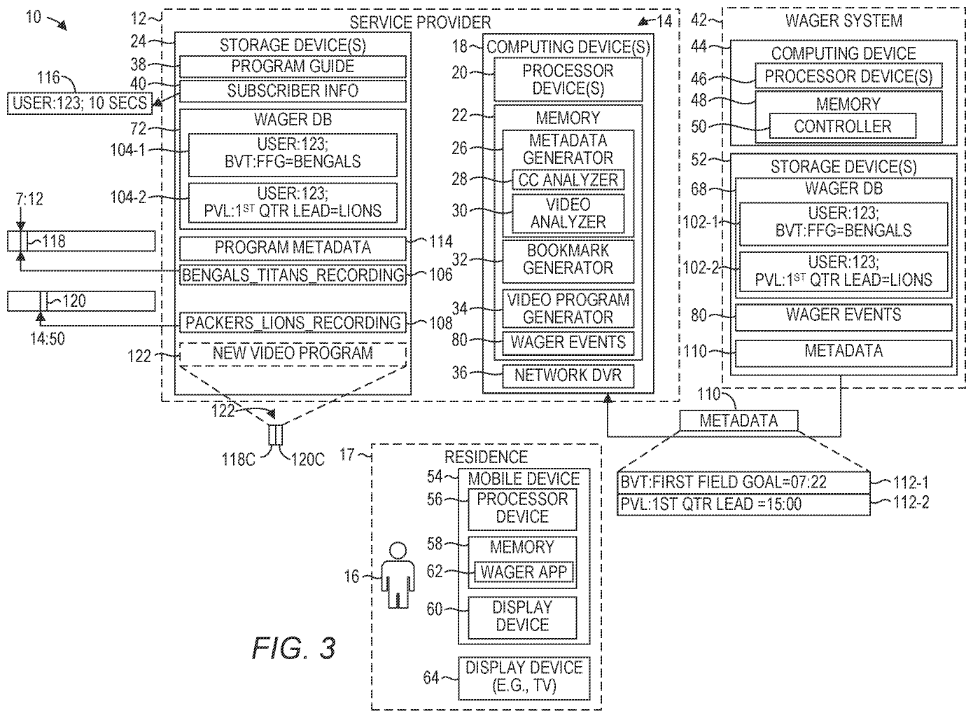

FIG. 3 is a block diagram of the environment 10 illustrating automatic wager segment generation for a parlay wager according to one embodiment. In this example, the subscriber 16 has placed a parlay wager that combines two bets into one wager and sent the wager information to the wager system 42 via the wager application 62. The parlay wager includes a first wager that the Bengals will make the first field goal in a game between the Bengals and the Titans, and a second wager that the Lions will have the lead at the end of the first quarter in a game between the Packers and the Lions. The computing device 44 has generated a wager record 102-1 that corresponds to the first wager and a wager record 102-2 that corresponds to the second wager. The computing device 44 sends the wager information to the computing system 14, which generates a wager record 104-1 that corresponds to the first wager and a wager record 104-2 that corresponds to the second wager.

The computing device 18 interacts with the network DVR 36 to cause the upcoming programs involving the Bengals and the Titans, and the Packers and the Lions, to be recorded. Subsequently, the two NFL programs occur, and the network DVR 36 generates a program recording 106 of the Bengals game and a program recording 108 of the Lions game. In this example, the computing device 18 receives metadata 110 from the wager system 42. The metadata 110 includes two time location records, a first time location record 112-1 corresponding to the first wager and indicating that the first field goal of the Bengals game occurred at 7:22 of the Bengals game, and a second time location record 112-2 corresponding to the second wager and indicating that the end of the first quarter occurred at 15:00 of the Lions game. The computing system 14 receives the metadata 110 and stores the metadata 110 as program metadata 114. Although not illustrated, the metadata 110 may include additional information, such as the identifier of the subscriber 16, the exact wager of the subscriber 16, and the like.

The computing system 14 accesses a subscriber record 116 that corresponds to the subscriber 16 and determines that the subscriber 16 has indicated that a wager segment associated with an event that corresponds to a wager should begin 10 seconds prior to the occurrence of the event. In this embodiment, the video program generator 34 identifies a wager segment 118 that has a wager segment location of 7:12 (i.e., 10 seconds earlier than the time location of 7:22) of the program recording 106 that is associated with the first wager. The video program generator 34 identifies a wager segment 120 that has a wager segment location of 14:50 (i.e., 10 seconds earlier than the time location of 15:00) of the program recording 108 that is associated with the second wager.

The video program generator 34 generates a new video program 122 that includes a copy 118C of the wager segment 118 and a copy 120C of the wager segment 120. The computing system 14 generates a user-selectable wager image for presentation on the display device 64 that, if selected by the subscriber 16, causes playback of the new video program 122.

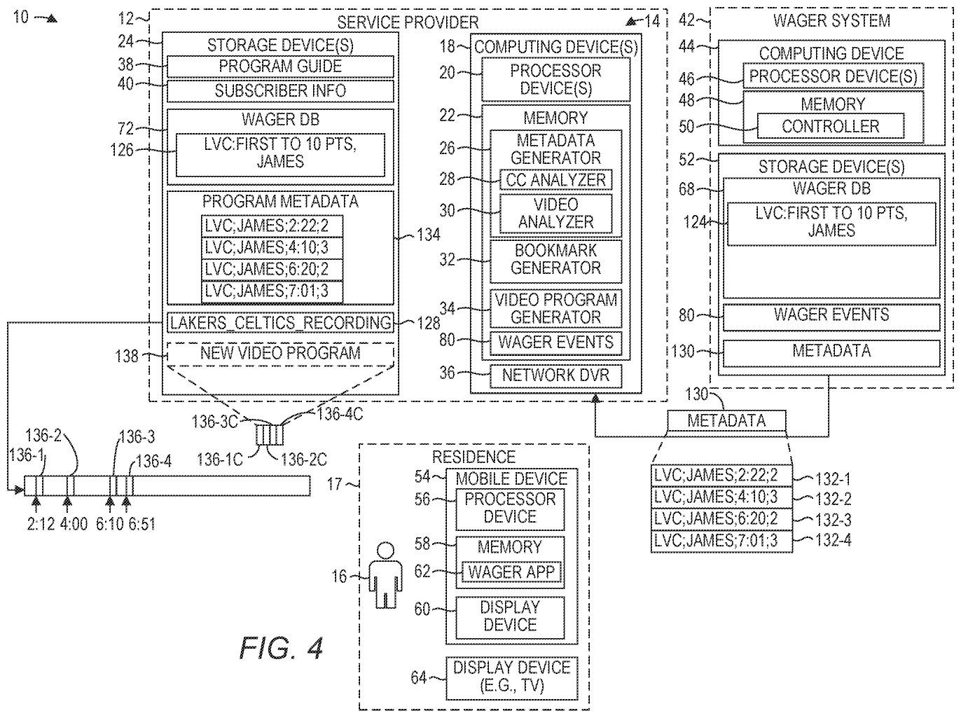

FIG. 4 is block diagram of the environment 10 illustrating automatic wager segment generation for a wager according to another embodiment. In this example, the subscriber 16, via the wager application 62, has placed a wager in an NBA game between the Lakers and the Celtics predicting that Lebron James will be the first player to score 10 points. The wager application 62 sends corresponding wager information to the computing device 44. The computing device 44 generates a wager record 124 that corresponds to the wager. The computing device 44 sends the wager information to the computing system 14, which generates a wager record 126 that corresponds to the wager.

The computing device 18 interacts with the network DVR 36 to cause the upcoming program involving the Lakers and Celtics to be recorded. Subsequently, the game is played, and the network DVR 36 generates a program recording 128 of the game. In this example, the wager event information 80 indicates that, for a wager regarding a player to be a first player to score a number of points, the events that correspond to such a wager are each of the points scored by the player up to the wagered amount, in this case ten points. If the wager was incorrect, the wager event information 80 indicates that the events include each of the points scored by the individual predicted by the wager, and each of the points by the player who actually was the first player to score ten points. The wager segments thus are a series of video segments showing both players as each scored points ending with the player who actually scored 10 points first.

In this example, assume that the wager correctly predicted that Lebron James would score ten points first. The wager system 42 generates metadata 130 that includes four time location records 132-1-132-4, each of which identifies a time of a score by Lebron James and the points scored. The computing system 14 receives the metadata 130 and stores the metadata 130 as program metadata 134. The video program generator 34 identifies a wager segment 136-1 that has a wager segment location of 2:12, a wager segment 136-2 that has a wager segment location of 4:00, a wager segment 136-3 that has a wager segment location of 6:10, and a wager segment 136-4 that has a wager segment location of 6:51.

The video program generator 34 generates a new video program 138 that includes a copy 136-1C of the wager segment 136-1, a copy 136-2C of the wager segment 136-2, a copy 136-3C of the wager segment 136-3, and a copy 136-4C of the wager segment 136-4. The computing system 14 generates a user-selectable wager image for presentation on the display device 64 that, if selected by the subscriber 16, causes playback of the new video program 138.

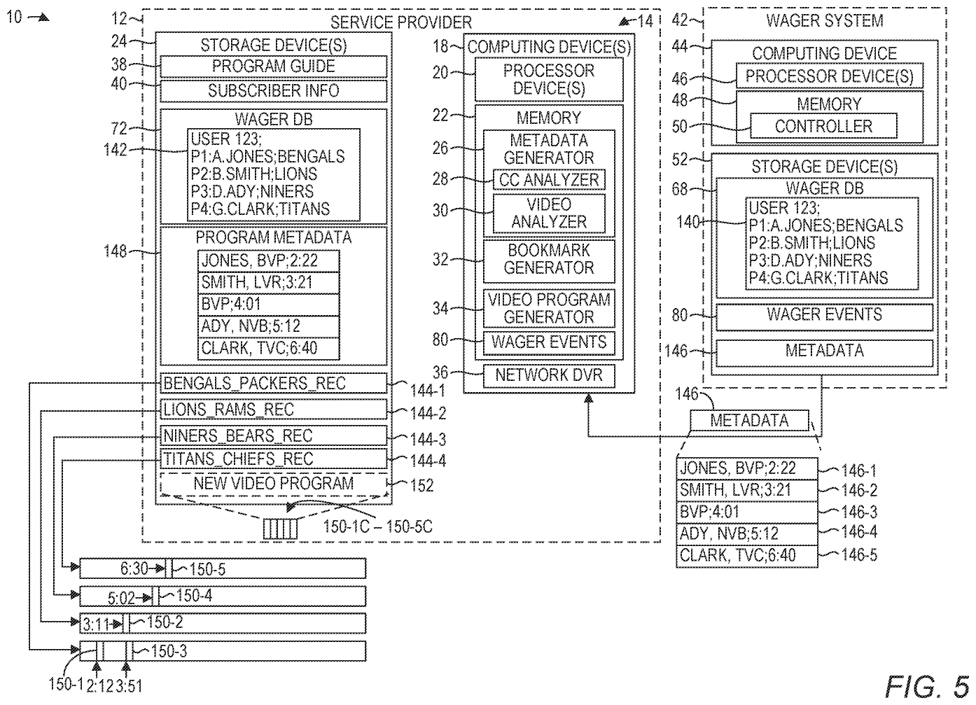

FIG. 5 is block diagram of the environment 10 illustrating automatic wager segment generation for a wager according to another embodiment. In this example, the subscriber 16, via the wager application 62, has placed a wager on a fantasy sports team, in particular, a fantasy sports team in a fantasy football league. The subscriber 16 selects a plurality of actual football players who play on actual football teams. For purposes of illustration and simplicity, the subscriber 16 has selected four players, but in practice, a fantasy football league may require the selection of more than four players. The subscriber 16 has selected a player named “A. Jones” who plays for the Bengals, a player named “B. Smith” who plays for the Lions, a player named “D. Ady” who plays for the Forty Niners, and a player named “G. Clark” who plays for the Titans.

Due solely to spatial limitations, FIG. 5 has omitted the residence 17. The wager application 62 sends corresponding wager information to the computing device 44. The computing device 44 generates a wager record 140 that corresponds to the wager. The computing device 44 sends the wager information to the computing system 14, which generates a wager record 142 that corresponds to the wager.

In this example, the computing device 18 interacts with the network DVR 36 to cause the upcoming programs involving the actual sports teams to be recorded, in this example, a Bengals vs. Packers game, a Lions vs. Rams game, a Niners vs. Bears game, and a Titans vs. Chiefs game. Subsequently, the games are played, and the network DVR 36 generates program recordings 144-1-144-4 that correspond, respectively, to the programs. In this example, the wager event information 80 indicates that the events that correspond to a wager regarding a fantasy football team are each event by a player on the fantasy football team that generates one or more points in the actual game in accordance with the rules of the fantasy football league. The wager event information 80 may identify each such event, such as a field goal, a touchdown, a run greater than 10 yards, a pass greater than 30 yards, and the like.

In this example, the wager system 42 generates metadata 146 that includes five time location records 146-1-146-5, each of which is a time location in the corresponding program for each of such events. For purposes of illustration and simplicity, there are only five such records, however in actual practice, it is likely that, for a complete fantasy football game, there could be tens or hundreds of such records and corresponding events. The computing system 14 receives the metadata 146 and stores the metadata as program metadata 148.

Based on the program metadata 148 and the subscriber preferences for the subscriber 16 identified in the subscriber information 40, the video program generator 34 identifies a wager segment 150-1 in the program recording 144-1 that has a wager segment location of 2:12, a wager segment 150-2 in the recording 144-2 that has a wager segment location of 3:11, a wager segment 150-3 in the program recording 144-1 that has a wager segment location of 3:51, a wager segment 150-4 in the recording 144-3 that has a wager segment location of 5:02, and a wager segment 150-5 in the recording 144-4 that has a wager segment location of 6:30.

In this embodiment, the video program generator 34 generates a new video program 152 that includes wager segments 150-1C-150-5C in chronological order of the game time of occurrences of the events across all the programs. Thus, the video program generator 34 generates the new video program 152 that includes a copy 150-1C of the wager segment 150-1, a copy 150-2C of the wager segment 150-2, a copy 150-3C of the wager segment 150-3, a copy 150-4C of the wager segment 150-4, and a copy 150-5C of the wager segment 150-5. The computing system 14 generates a user-selectable wager image for presentation on the display device 64 that, if selected by the subscriber 16, causes playback of the new video program 152.

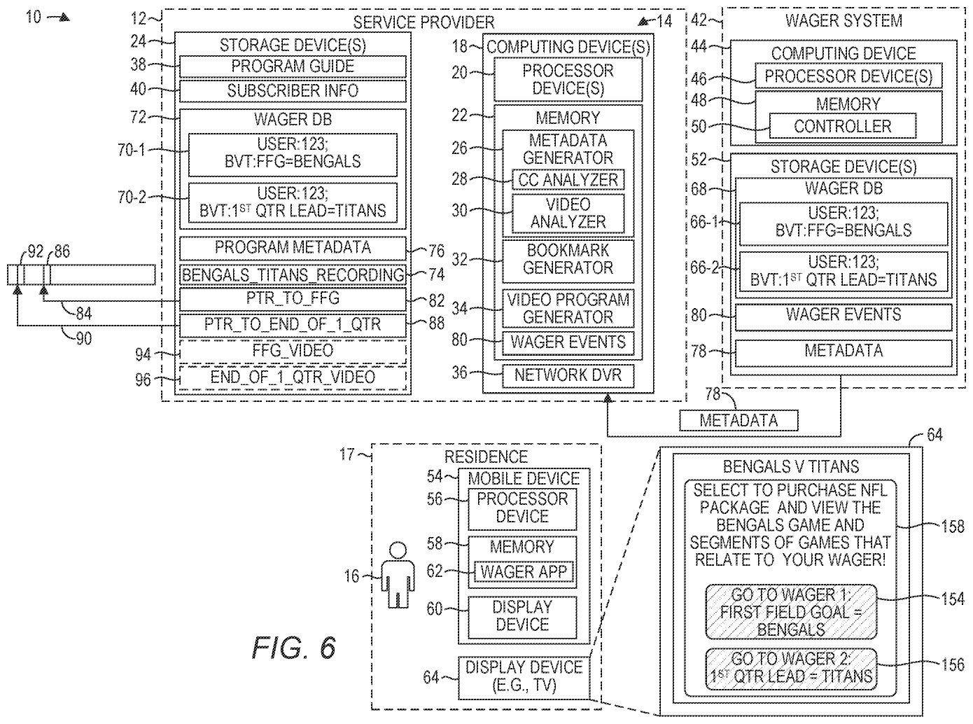

FIG. 6 is a block diagram of the environment illustrated in FIGS. 1A-1C illustrating automatic wager segment generation for a wager according to yet another embodiment. The description for FIG. 6 is identical to that of FIGS. 1A-1C except as otherwise discussed herein. In this embodiment, the computing device 18 determines that the subscriber 16 does not have a subscription that allows the subscriber 16 to view the program(s) on which the wager has been made. The computing device 18 nevertheless causes the network DVR 36 to generate the program recording 74 and generates the new video programs 94 and 96 in the same manner as discussed above with regard to FIGS. 1A-1C. The computing device 18 also generates wager images 154 and 156 that are non-selectable. In this embodiment, when the subscriber 16 attempts to stream content from the service provider 12, the computing device 18 may generate information 158 that indicates that the subscriber 16 does not have a subscription to view the program. The information 158 may also include grayed-out wager images 154 and 156 to indicate that the subscriber 16 cannot currently view the wager segments 86, 92 that correspond to the wagers, but, upon acquisition of the appropriate subscription, would be able to select the wager images 154 and 156 to view the wager segments 86, 92 that correspond to the wagers.

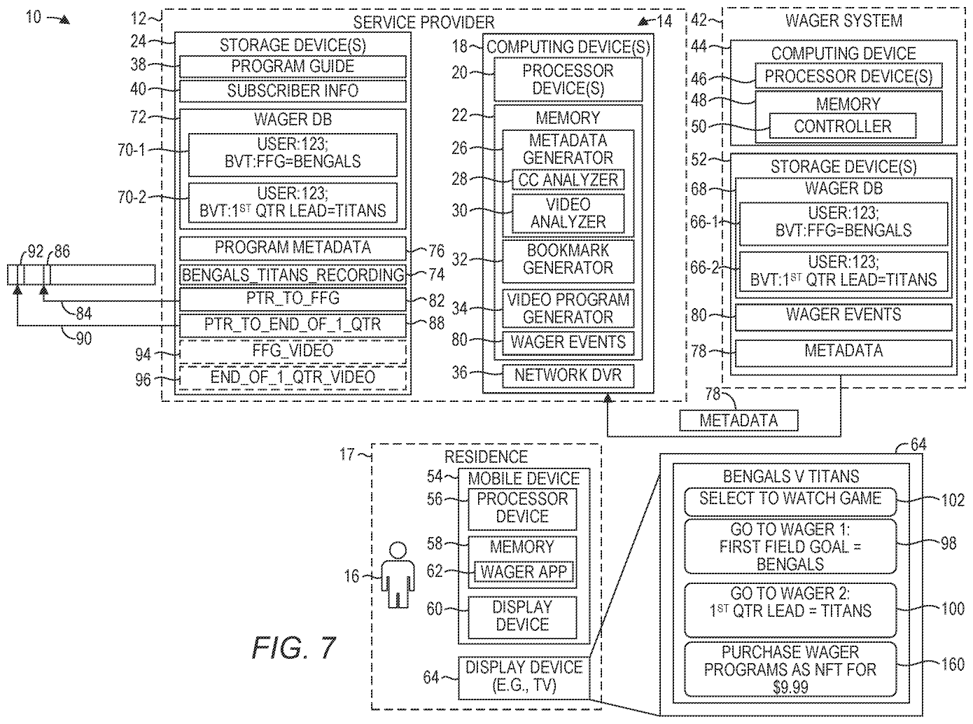

FIG. 7 is a block diagram of the environment illustrated in FIGS. 1A-1C illustrating automatic wager segment generation for a wager according to yet another embodiment. The description for FIG. 7 is identical to that of FIGS. 1A-1C except as otherwise discussed herein. In this embodiment, the computing device 18 allows a transfer of ownership of the new video programs 94 and 96 to the subscriber 16. In particular, in this embodiment, the computing device 18 streams a user-selectable image 160 that, if selected by the subscriber 16, transfers ownership of the new video programs 94 and 96 to the subscriber 16 for a fee. In some embodiments, the computing device 18 may generate a non-fungible token (NFT) of the new video programs 94 and 96 and provide access to the NFT by the subscriber 16.

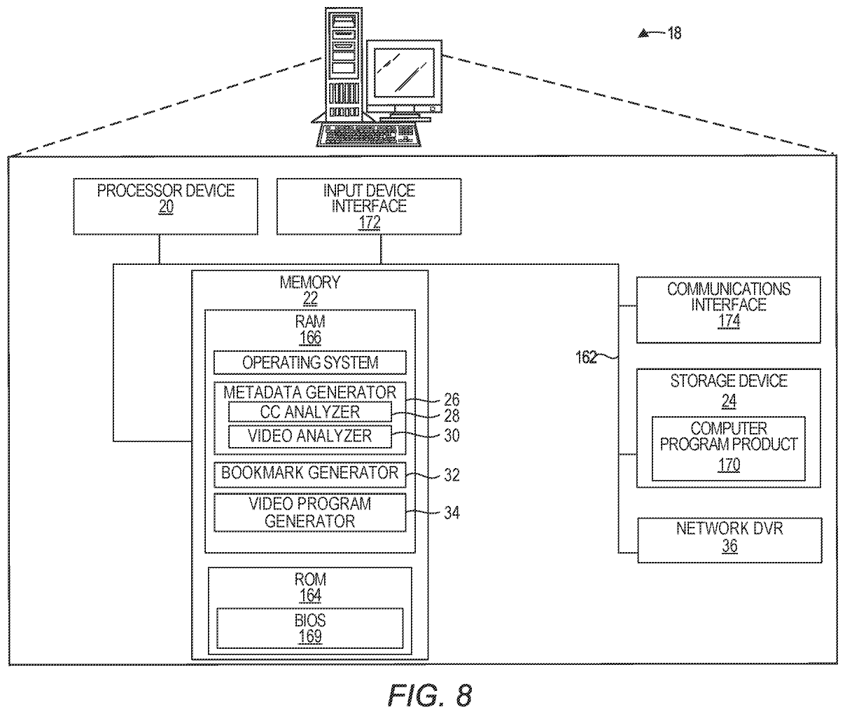

FIG. 8 is a block diagram of the computing device 18 suitable for implementing examples according to one example. The computing device 18 may comprise any computing or electronic device capable of including firmware, hardware, and/or executing software instructions to implement the functionality described herein, such as a computer server, or the like. The computing device 18 includes the processor device 20, the memory 22, and a system bus 162. The system bus 162 provides an interface for system components including, but not limited to, the memory 22 and the processor device 20. The processor device 20 can be any commercially available or proprietary processor device.

The system bus 162 may be any of several types of bus structures that may further interconnect to a memory bus (with or without a memory controller), a peripheral bus, and/or a local bus using any of a variety of commercially available bus architectures. The memory 22 may include non-volatile memory 164 (e.g., read-only memory (ROM), erasable programmable read-only memory (EPROM), electrically erasable programmable read-only memory (EEPROM), etc.), and volatile memory 166 (e.g., random-access memory (RAM)). A basic input/output system (BIOS) 169 may be stored in the non-volatile memory 164 and can include the basic routines that help to transfer information between elements within the computing device 18. The volatile memory 166 may also include a high-speed RAM, such as static RAM, for caching data.

The computing device 18 may further include or be coupled to a non-transitory computer-readable storage medium such as the storage device 24, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, network storage, block storage, or the like. The storage device 24 and other drives associated with computer-readable media and computer-usable media may provide non-volatile storage of data, data structures, computer-executable instructions, and the like.

A number of modules can be stored in the storage device 24 and in the volatile memory 166, including an operating system and one or more program modules, such as the metadata generator 26, the bookmark generator 32, and the video program generator 34, which may implement the functionality described herein in whole or in part.

All or a portion of the examples may be implemented as a computer program product 170 stored on a transitory or non-transitory computer-usable or computer-readable storage medium, such as the storage device 24, which includes complex programming instructions, such as complex computer-readable program code, to cause the processor device 20 to carry out the steps described herein. Thus, the computer-readable program code can comprise software instructions for implementing the functionality of the examples described herein when executed on the processor device 20.

An operator may also be able to enter one or more configuration commands through a keyboard (not illustrated), a pointing device such as a mouse (not illustrated), or a touch-sensitive surface such as a display device. Such input devices may be connected to the processor device 20 through an input device interface 172 that is coupled to the system bus 162 but can be connected by other interfaces such as a parallel port, an Institute of Electrical and Electronic Engineers (IEEE) 1394 serial port, a Universal Serial Bus (USB) port, an IR interface, and the like. The computing device 18 may also include a communications interface 174 suitable for communicating with a network as appropriate or desired.

Those skilled in the art will recognize improvements and modifications to the preferred embodiments of the disclosure. All such improvements and modifications are considered within the scope of the concepts disclosed herein and the claims that follow.

1. A method comprising:
receiving, by a computing system comprising one or more processor devices, wager information that identifies a wager;
determining, by the computing system, a program that corresponds to the wager;
subsequently determining, by the computing system, a wager segment of the program, the wager segment being associated with the wager; and
causing, by the computing system on a display device, presentation of a user-selectable wager image that corresponds to the wager segment.

2. The method of claim 1 wherein the program comprises a program of a future sporting event, and wherein the wager comprises a wager associated with the future sporting event.

3. The method of claim 1 wherein the wager comprises a wager associated with a fantasy sports team comprising at least one actual player who plays for an actual sports team, and wherein the program comprises a program of the actual sports team competing against another sports team.

4. The method of claim 1 further comprising:
determining, by the computing system, a subscriber who placed the wager;
determining, by the computing system, that the program has not been set to be recorded for the subscriber; and
in response to determining that the program has not been set to be recorded for the subscriber, automatically causing, by the computing system, the program to be recorded in a network digital video recorder for subsequent access by the subscriber.

5. The method of claim 1 further comprising:
determining, by the computing system, a subscriber who placed the wager;
determining, by the computing system, that the program comprises two future programs that have not been set to be recorded for the subscriber; and
in response to determining that the two future programs have not been set to be recorded for the subscriber, automatically causing, by the computing system, the two future programs to be recorded in a network digital video recorder for subsequent access by the subscriber.

6. The method of claim 1 wherein the user-selectable wager image identifies the wager.

7. The method of claim 1 wherein subsequently determining the wager segment further comprises:
determining that the wager corresponds to an event that occurred in the program;
accessing metadata that identifies a time location associated with the event in the program;
determining the wager segment to begin at a wager segment location of a recording of the program based on the time location;
generating a pointer to the wager segment location in the recording of the program; and
correlating the pointer to the user-selectable wager image such that a selection of the user-selectable wager image causes an initiation of playback of the recording of the program at the wager segment location.

8. The method of claim 1 wherein subsequently determining the wager segment further comprises:
determining that the wager corresponds to an event that occurred in the program;
accessing metadata that identifies a time location associated with the event in the program;
determining the wager segment to begin at a wager segment location of a recording of the program based on the time location;
generating, based on the wager segment location, a new video program that includes a copy of the wager segment;
storing the new video program on a storage device; and
correlating the new video program to the user-selectable wager image such that selection of the user-selectable wager image causes an initiation of playback of the new video program.

9. The method of claim 1 wherein subsequently determining the wager segment further comprises:
determining that the wager corresponds to an event that occurred in the program;
receiving, from a server, metadata that identifies a time location associated with the event in the program; and
determining the wager segment based on the metadata.

10. The method of claim 1 wherein subsequently determining the wager segment further comprises:
determining that the wager corresponds to an event that occurred in the program;
processing a recording of the program to identify the event that corresponds to the wager; and
determining the wager segment based on a time location of the event that occurred in the program.

11. The method of claim 1 further comprising:
determining, by the computing system, a subscriber associated with the wager;
determining, by the computing system, that the subscriber has a subscription that does not include the program; and
causing, by the computing system on the display device, presentation of information that identifies the wager and the program and that indicates that the subscriber has the subscription that does not include the program.

12. The method of claim 1 wherein the wager corresponds to a plurality of events that occurred in the program, and further comprising:
accessing metadata that identifies a plurality of different time locations, each different time location corresponding to one of the plurality of events in the program;
determining a plurality of wager segments to begin at a corresponding plurality of wager segment locations of a recording of the program based on the plurality of different time locations;
generating, from the recording and based on the plurality of wager segment locations, a new video program that comprises a copy of each of the wager segments;
storing the new video program on a storage device; and
correlating the new video program to the user-selectable wager image such that a selection of the user-selectable wager image causes an initiation of the new video program.

13. The method of claim 1 wherein the wager is a first wager in a parlay wager comprising the first wager and a second wager, and wherein the wager segment of the program is a first wager segment of a first program, and further comprising:
determining a second program that corresponds to the second wager in the parlay wager;
accessing metadata that identifies a first time location associated with a first event in the first program that is associated with the first wager;
accessing metadata that identifies a second time location associated with a second event in the second program that is associated with the second wager;
determining the first wager segment to begin at a first wager segment location of a recording of the first program based on the first time location;
determining a second wager segment to begin at a second wager segment location of a recording of the second program based on the second time location;
generating, from the recording of the first program and the recording of the second program, based on the first wager segment location and the second wager segment location, a new video program that comprises a copy of the first wager segment and a copy of the second wager segment;
storing the new video program on a storage device; and
correlating the new video program to the user-selectable wager image such that a selection of the user-selectable wager image causes an initiation of the new video program.

14. The method of claim 1 wherein the wager comprises a wager associated with a fantasy sports team comprising a plurality of players who play for a corresponding plurality of actual sports teams, and wherein the program comprises a plurality of programs of the actual sports teams competing against other sports teams, and wherein the wager corresponds to a plurality of events that occurred in the plurality of programs, and further comprising:
accessing metadata that identifies a plurality of time locations, each time location corresponding to an event of the plurality of events in a corresponding program of the plurality of programs;
determining a plurality of wager segments, each of which begins at a corresponding wager segment location of a plurality of wager segment locations, by, for each respective time location of the plurality of time locations, determining a respective wager segment to begin at a corresponding wager segment location of a recording of a program of the event to which the respective time location corresponds;
generating, from a plurality of recordings of the plurality of programs, based on the plurality of wager segments, a new video program that comprises a copy of each of the plurality of wager segments;
storing the new video program on a storage device; and
correlating the new video program to the user-selectable wager image such that selection of the user-selectable wager image causes an initiation of the new video program.

15. The method of claim 1 wherein subsequently determining the wager segment further comprises:
determining that the wager corresponds to an event that occurred in the program;
accessing metadata that identifies a time location associated with the event in the program;
determining the wager segment to begin at a wager segment location of a recording of the program based on the time location;
generating, based on the wager segment location, a new video program that includes a copy of the wager segment;
storing the new video program on a storage device; and
causing, by the computing system on the display device, presentation of information that, upon selection, transfers ownership of the new video program to a subscriber.

16. The method of claim 15 further comprising:
generating a non-fungible token (NFT) of the new video program; and
providing access to the NFT to the subscriber.

17. The method of claim 1 further comprising causing, by the computing system on the display device, presentation of the wager segment.

18. A computing system comprising:
one or more processor devices of one or more computing devices, the one or more processor devices configured to:
receive wager information that identifies a wager;
determine a program that corresponds to the wager;
subsequently determine a wager segment of the program, the wager segment being associated with the wager; and
cause, on a display device, presentation of a user-selectable wager image that corresponds to the wager segment.

19. The computing system of claim 18 wherein, to subsequently determine the wager segment, the one or more processor devices are further to:
determine that the wager corresponds to an event that occurred in the program;
access metadata that identifies a time location associated with the event in the program;
determine the wager segment to begin at a wager segment location of a recording of the program based on the time location;
generate, based on the wager segment location, a new video program that includes a copy of the wager segment;
store the new video program on a storage device; and
correlate the new video program to the user-selectable wager image such that selection of the user-selectable wager image causes an initiation of playback of the new video program.

20. A non-transitory computer-readable storage medium that includes executable instructions configured to cause one or more processor devices to:
receive wager information that identifies a wager;
determine a program that corresponds to the wager;
subsequently determine a wager segment of the program, the wager segment being associated with the wager; and
cause, on a display device, presentation of a user-selectable wager image that corresponds to the wager segment.
